(19) United States
(12) Patent Application Publication
(10) Pub. No.: US 2003/0078962 A1
(43) Pub. Date: Apr. 24, 2003

(54) Integrated communications system

(76) Inventors: Robert Fabbricatore, Wolfeboro, NH (US); Frederic Kunzi, Shirley, MA (US); Thomas Pagan, Hanson, MA (US); Aaron Bruneau, Lakeville, MA (US); Asfar Mohammad Towheed, Framingham, MA (US); Thomas Fabbricatore, Medway, MA (US); Russell Oliver, Worcester, MA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/981,914

(22) Filed: Oct. 19, 2001

(51) Int. Cl. G06F 17/60; G06F 15/16

(52) U.S. Cl. 709/203; 705/1

(57) ABSTRACT

An Advanced Packet Based Integrated Communications System has the ability to provide commercial customers with converged services including local and long distance voice, data communications and videoconferencing and which also provides a platform to deliver value added services such as managed services, hosting, storage, messaging, and E-Business content. The integrated communications system comprises an integrated packet-based network infrastructure operable to provide networked converged communications, an information management platform operable to support handling of orders, initiating services provisioning, maintaining service quality, billing, and administration, and an activation engine operable to provide end-to-end services provisioning. The integrated packet-based network infrastructure replaces a traditional circuit switched network.

### FIELD OF THE INVENTION

The present invention relates to an Advanced Packet Based Integrated Communications System (ICS) that provides commercial customers with converged services including local and long distance voice, data communications, videoconferencing as well as a platform to deliver value added services such as managed services, hosting, storage, messaging, and E-Business content.

### BACKGROUND OF THE INVENTION

Traditionally many enterprises would contract different carriers for various telecommunications services. As an example, a mid size real-estate company operating along the east coast of the United States may have services from multiple competitive local exchange carriers (CLECs), incumbent local exchange carriers (ILECs), interexchange carriers (IXCs), internet service providers (ISPs) and other data services providers. Such an environment requires daily interactions to manage ongoing operations, dealing with multiple facilities, multiple bills and associated administrative overhead. It is complex, expensive, cumbersome and heavily time consuming. A need arises for a solution that provides an integrated communications system that reduces the number of telecommunications vendors that are required to provide services, reduces the number of facilities required at the customer location, reduces interactions to manage ongoing operations, simplifies dealing with bills and reduces associated administrative overhead.

### SUMMARY OF THE INVENTION

In summary, the invention is a unique and integrated communications system (ICS) that combines all voice and data communications on a single systems architecture and a single connection to the user and enables communication between that user and any other person, business, data base or information source in the world. The overall system integrates three primary sub-systems that enable voice and data communications at substantially lower cost, significantly higher functionality and meet or exceed all technical and operating standards. The invention, although totally different from current art, is a 100% replacement for the current art.

The present invention is an integrated communications system (ICS) architecture, an example of which is shown in FIG. 1, and a service delivery structure, an example of which is shown in FIGS. 5 and 6, that together provide convergence of multiple telecommunications services on a single path to commercial customers. Access to the ICS at the customer premises is provided by an Integrated Access Device, which serves as the point of demarcation between the service provider and the customer and which is managed and operated by the service provider. The way the network is engineered is unique in that the packet switching and routing infrastructure reside in a centralized location, termed a super point of presence (SPOP). The super point of presence preferably makes use of a fiber-based infrastructure to reach customers. This provides significant advantages compared to the distributed circuit-switched and service specific network infrastructure residing in Local Central Offices, as it is today in the traditional carrier's network environment.

The present invention provides an integrated communications system (ICS) that enables a base for universal telecommunications applications. Systems within the present invention permit replacing current circuit switched based infrastructure while at the same time enhancing value for its customers. For example, the same real-estate company mentioned earlier can access all of its services by connecting to an integrated communications system in accordance with the present invention. An ICS in accordance with the present invention can provide a single point of contact for a commercial user, and allows a commercial user to easily upgrade and change its services. In accordance with another aspect of the present invention, a customer can receive one detailed bill that includes on-net information tracking the customer's organization down to individual users. In addition, an ICS in accordance with the present invention can provide a user with on-net information on services performance and usages.

When compared with current carrier and service provider networks, the level of integration that has been achieved between the network, the activation engine and the information management platform provides the capability to order, provision, bill and support services with a high level of automation. It also sets the base for future value added services including desktop and application services convergence.

Utilizing services over conventional copper lines, in particular in the middle mile (the network segment between a carrier's point of presence and the Local Central Office), is subject to frequent outage and ultimately service interruptions. In one embodiment of the present invention, the ICS has an architecture that is based on a centralized model. This embodiment concentrates switching and routing functions as well as an information management platform within major Super Points of Presence (SPOPs). Access to customers is provided through long-haul (inter-city) based fiber infrastructure, as shown in FIG. 7 and Metro (intra-city) based fiber infrastructure, as shown in FIGS. 7 and 8. The fiber rings shown in FIGS. 7 and 8 are built using, for example, Dense Wavelength Division Multiplexing (DWDM), and Synchronous Optical Networks (SONET) technology. These technologies provide a self-healing fully redundant and robust (high availability) transport infrastructure. This transport concept enables the delivery of reliable and redundant long haul and middle mile connectivity in a relatively short time. Near real time provisioning is feasible. This provides a great improvement over the current art, which has average delivery time of weeks to months. Making use of services based on the current art of circuit switched technology is not efficient, as it monopolizes bandwidth that could be dynamically shared for other transmission requirements. Current art is typified by inefficient bandwidth allocation requiring higher bandwidth consumption at a higher cost.

Packet technology brings a tremendous advantage to enterprise customers. As an analogy, it works in the same context as building a highway for a single car versus sharing the highway with a multitude of other cars, trucks and vehicles of any type. Dedicating a highway to a single car equals the dedication of a traditional phone line to a single voice conversation; all of the available bandwidth is used by one customer. A packet-based system allows many customers to use the same transport infrastructure for various types of communications (e.g., voice, data, videoconferencing etc.). This is analogous to multiple cars of any type sharing the same highway. An additional advantage is that it allows for dynamic bandwidth allocation. For instance, using various service levels provides the capability to allocate pre-reserved voice bandwidth to data traffic while voice is not in use. Finally, it provides the capability to differentiate and prioritize various services that make use of quality of services (QoS). The integration of these technologies provides a tremendous advantage over current art network build-outs making use of circuit switching technology. Receiving multiple bills from diverse sources and having to reconcile information and supporting ongoing operational events such as additions, changes and potential outages, requires skilled resources and a good understanding of the telecommunications industry. The Integrated Communications System of the present invention provides a platform that delivers near real time information available to customers. Customers have access to billing and usage information, which is a powerful tool to keep in touch with ongoing expense control. Evolving the enterprise to support strategic business objectives demands a network platform that is highly integrated with systems and applications. This is a difficult challenge when receiving services based on current art circuit switched platforms.

Customers want lower costs and higher functionality telecommunications services that reduce their costs and improve the efficiency of their business. Receiving converged telecommunications services opens the door to a whole line of value added services, such as Hosting Services, Storage (Backup and disaster recovery services), Messaging, etc. These value-added services are fully integrated with the Integrated Communications System of the present invention

### BRIEF DESCRIPTION OF THE DRAWINGS

FIG. 1 is a schematic block diagram of an integrated communications systems architecture in accordance with the present invention.

FIG. 2 is a schematic diagram of an integrated communications systems network Infrastructure architecture in accordance with the present invention. It represents a first implemented stage.

FIG. 3 is a schematic diagram of an integrated Communications Systems Network Architecture in accordance with the present invention. It shows the evolution of the Network Architecture making use of emerging standards and technologies. This diagram shows a second implementation stage.

FIG. 4 is a schematic diagram of an integrated Communications Systems Network Architecture in accordance with the present invention. It shows the evolution of the Network Architecture making use of emerging standards and technologies. This diagram shows a third implementation stage.

FIG. 5 is a schematic diagram of an integrated Communications Systems Packet-Based Converged Services Infrastructure in accordance with the present invention. It shows the end-to-end infrastructure necessary of providing commercial users with converged telecommunications services.

FIG. 6 is a schematic diagram of an integrated Communications Systems illustration of converged services in accordance with the present invention. It shows how commercial end-users will be connected to converged telecommunications services.

FIG. 7 is a schematic diagram of an integrated Communications Systems Long Haul and Metro fiber transport concept in accordance with the present invention. It illustrates how inter-city and intra-city fiber transport are provided.

FIG. 8 is a schematic diagram of an integrated Communications Systems Metro fiber transport concept in accordance with the present invention. It illustrates how Metro (intra-city) fiber and copper transport media are provided to support converged services access to commercial end-users.

FIG. 9 is a schematic diagram of an integrated Communications Systems Activation Engine Concept in accordance with the present invention. It shows the Activation Engine Concept that support end-to-end flow-through services provisioning.

FIG. 10 is a schematic diagram of an integrated Communications Systems Information Management Platform in accordance with the present invention. It shows the Information Management Platform that supports the ICS systems and applications.

### DETAILED DESCRIPTION OF THE INVENTION

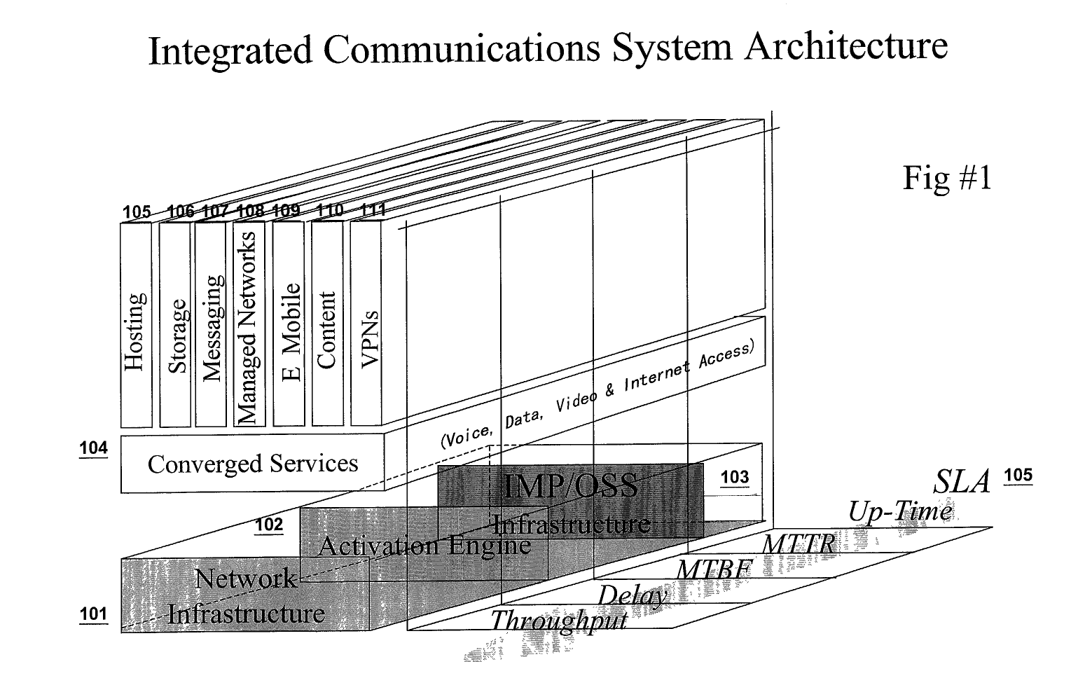

An embodiment of an integrated communications system (ICS), in accordance with the present invention, is shown in FIG. 1. The embodiment includes three major highly integrated components: a packet based integrated network infrastructure (PBINI) 101, an activation engine (AE) 102, and a supporting Information Management Platform (IMP) 103. The integrated network infrastructure 101 is the basic building block of the ICS. Preferably it is based on packet technology Internet Protocol (IP) plus Asynchronous Transfer Mode (ATM) traveling over a Fiber transport layer making use of Synchronous Optical Network (SONET) and Dense Wavelength Division Multiplexing (DWDM) technologies.

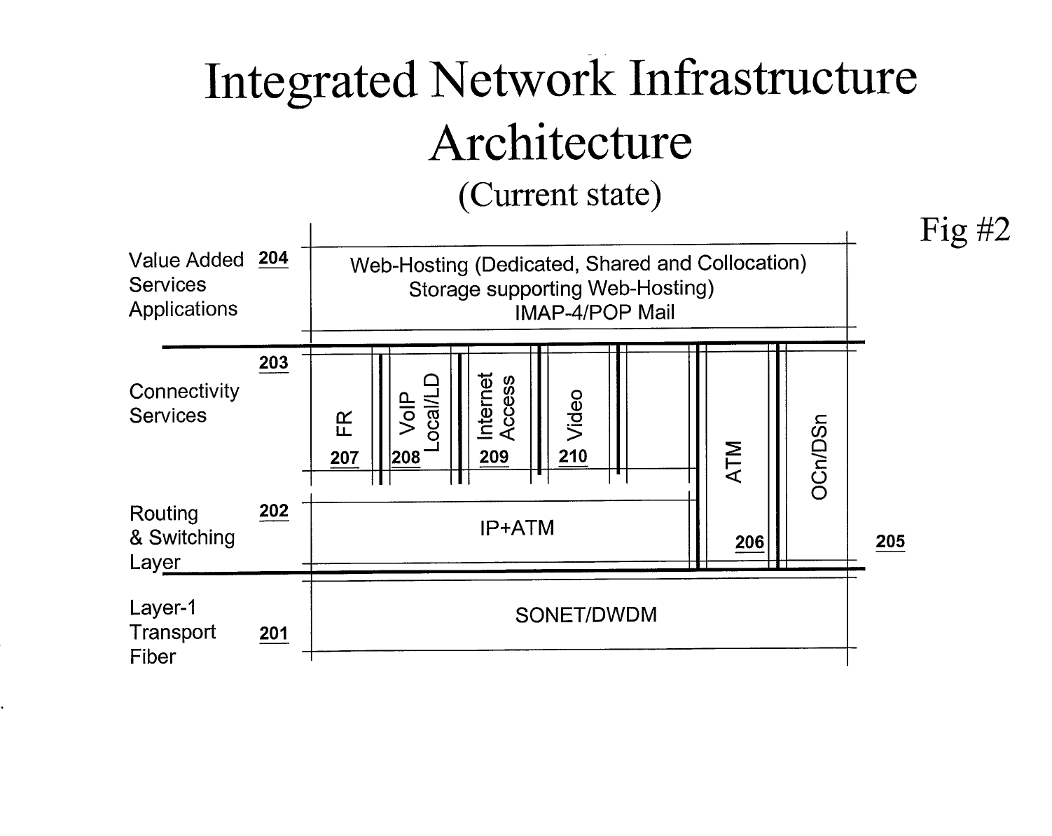

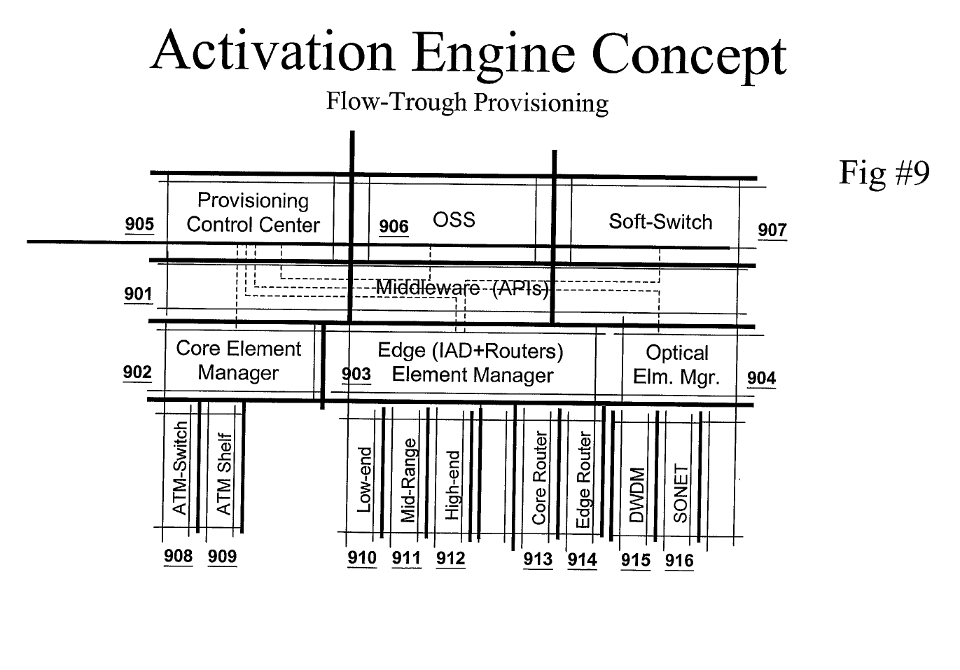

The Activation Engine 102 provides the integration between the integrated network infrastructure and the Information management platform it provides the base for end-to-end flow-through services provisioning. The Activation Engine (AE), shown in more detail in FIG. 9, provides the capability to execute the provisioning of services that are initiated by the IMP FIG. #10. The AE building blocks include a series of network elements or software components that are integrated into all network equipment sets of the ICS. These network elements allow the flow of information to and from the network enabling the automation of end-to-end service provisioning across multiple network layers, as shown in FIG. 2. A series of service modules also software components are built into the AE providing the configuration information necessary to setup services chosen by customers. From a structural point of view FIG. 9 shows the various components that have been integrated to shape the AE.

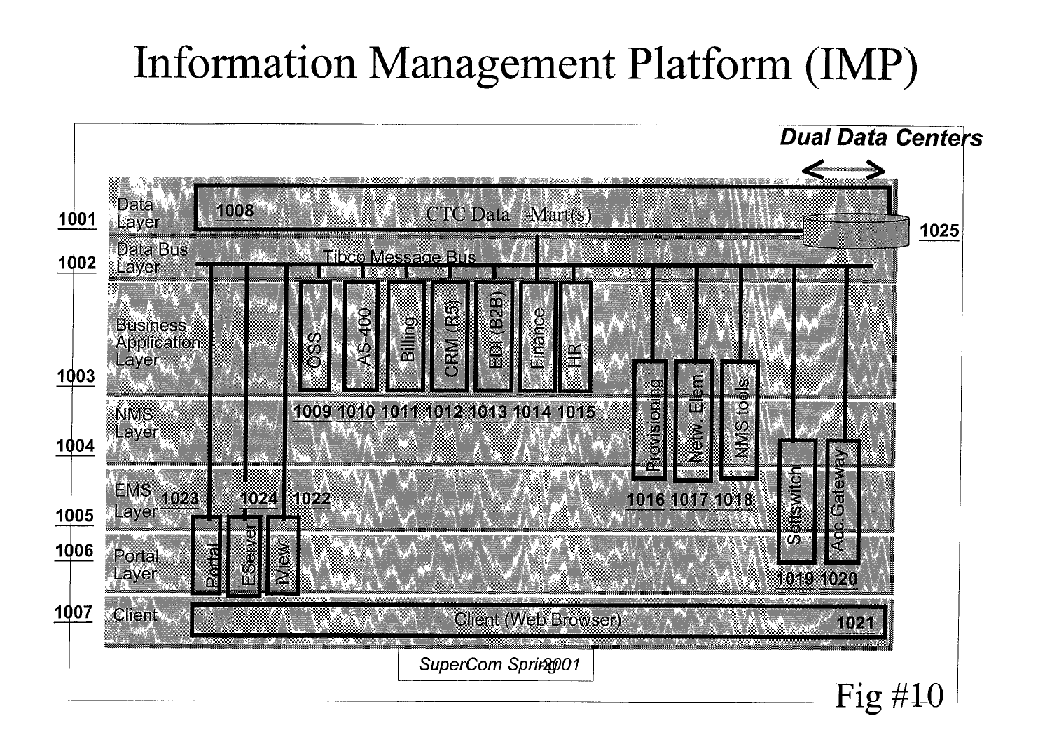

The Information Management Platform 103, shown in more detail in FIG. 10, integrates all systems needed not only to manage that network and value added services infrastructure but literally all systems that are needed to run the business of the network operator. The Information Management Platform 103 including all systems and applications supporting the handling of orders, the initiation of provisioning services, maintaining service quality, billing and administration. A key component of the IMP architecture is its data bus or middleware 1002. The data bus is the link to various layers and enables information to flow from and to all systems making use of standard data driven Applications Protocol Interfaces (APIs). The IMP permits the ordering, provisioning, billing and maintenance of all services that the network operator offers to its customers. The IMP encompasses the Operations Support System (OSS), the Customer Relationship Management system (CRM), the Billing System, a Business-to-Business engine ensuring the intercommunication with partners and peering carriers, and a series of functional systems supporting finance and human resources requirements.

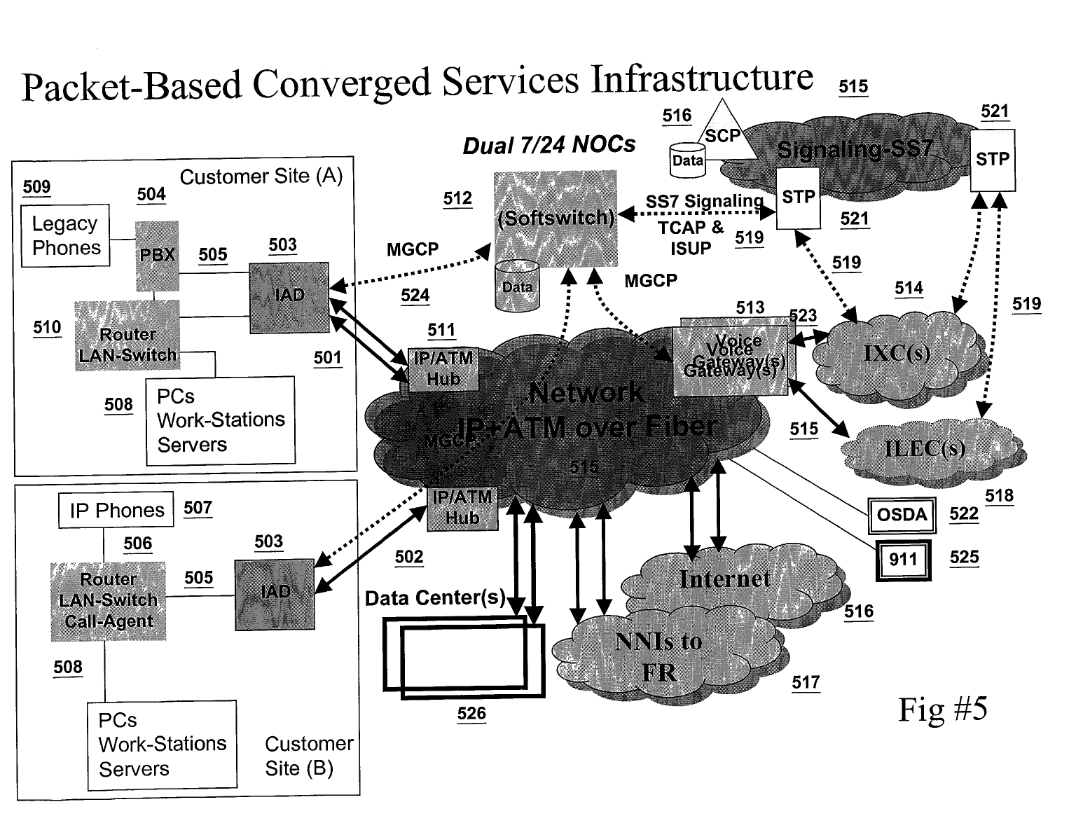

Converged Services 104 are delivered to commercial customers over fiber or copper leased facilities using an Integrated Access Device (IAD) 503 that is installed at the customer premises. Commercial customers can connect both their legacy or packet based compatible voice, data, and video infrastructure. An Integrated Access Device (IAD) 503, shown in more detail in FIG. 5, is a network device that allows the bundling of various telecommunication services into one single packet network infrastructure. It is the tunnel that combines local and long distance voice, Intranet, Extranet and Internet data requirements, as well as videoconferencing. The IAD is the point of demarcation between the network operator and its customers it is also the extension of the ICS to the customer site. Structurally the IAD also includes router and firewall functionalities. Customers can connect any of their telecommunications equipment as the IAD can adapt to analog and digital interfaces and handle divers protocols.

Value added services (VAS) are provided above converged services. Web hosting 105 supporting shared, dedicated and collocation services, Storage services 106 providing backup and disaster recovery solutions, Messaging 107 with email and soon unified messaging services, Managed Network Services 108 providing intranet management capabilities, E-mobile 109 providing access and content to mobile users, network and application content 110 as well as IP virtual private networks (IP/VPN). The ICS infrastructure has been built with Service Level Agreement (SLA) capabilities that span across all building blocks.

An embodiment of a packet based integrated network infrastructure architecture (PBINI) 101, shown in FIG. 1, is shown in FIG. 2. The PBINI architecture includes a transport layer 201 built on fiber with DWDM and SONET technologies. It provides a Path Protected Meshed environment where both SONET rings and point-to-point SONET connections can be delivered. The DWDM technology brings the flexibility and the ability to scale for bandwidth demand with the potential to light up additional lambdas on demand. Each lambda will carry up to an OC192 capacity that is equivalent to 192×45 Mbps. One fiber strand can provide up to 128 Lambdas.

The switching and routing layers 202 are based on IP plus ATM technologies, they provide the switching and routing fabric to carry converged traffic across the core network infrastructure and to and from the edge of the ICS supported by IADs. The Connectivity layer 203 supports end-user communications services, such as the converged services, 207 Frame Relay (FR) services, 208 Voice over IP (VoIP) with local and long distance calling capabilities, 209 extending Internet access services, and 210 providing Videoconferencing services. ATM over SONET 206 as well as Optical Carrier (OCn) and Digital Signal (DSn) services 205 can be delivered a side to converged services. The Value Added Services Layer 204 supports web hosting, storage, and messaging services.

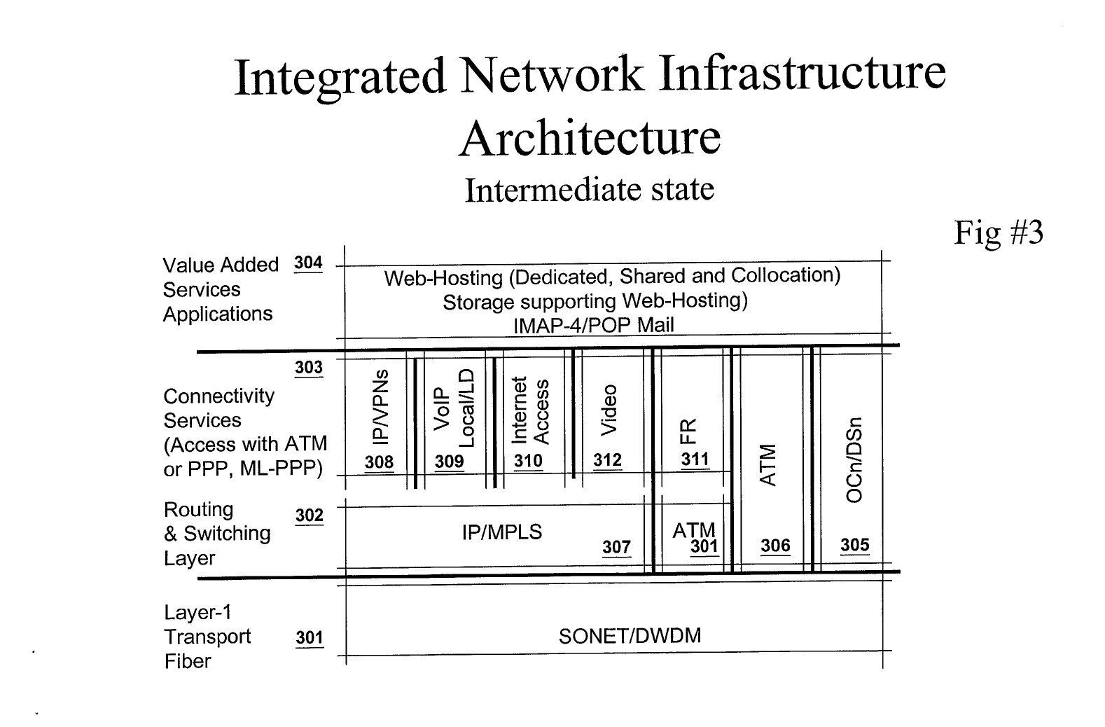

An embodiment of a packet based integrated network infrastructure architecture (PBINI) 101, shown in FIG. 1, is shown in FIG. 3 in accordance with the present invention. FIG. 3 shows an embodiment of the PBINI 101 that includes Multi-protocol Label Switching (MPLS) 302. MPLS 302 is a standard technology for speeding up network traffic flow and making it easier to manage. MPLS 302 involves setting up a specific path for a given sequence of packets, identified by a label put in each packet, thus saving the time needed for a router to look up the address to the next node to forward the packet to. MPLS is called multi-protocol because it works with the Internet Protocol (IP), Asynchronous Transport Mode (ATM), and frame relay network protocols. With reference to the standard model for a network (the Open Systems Interconnection, or OSI model), MPLS allows most packets to be forwarded at the layer 2 (switching) level rather than at the layer 3 (routing) level. In addition to moving traffic faster overall, MPLS makes it easy to manage a network for quality of service (QoS). It permits partitioning and secure network resources by introducing the IP Virtual Private Network (IP/VPNs) concept. In this embodiment, ATM is taken out of the core network and is replaced by an IP over SONET structure. At the edge 302, both ATM with QoS and Inverse Multiplexing for ATM (IMA) or Point to Point Protocol (PPP) or Multi-Link-PPP (ML-PPP) can be applied. Here Frame Relay could be alternatively provided over ATM or IP/MPLS depending on the option chosen at the edge.

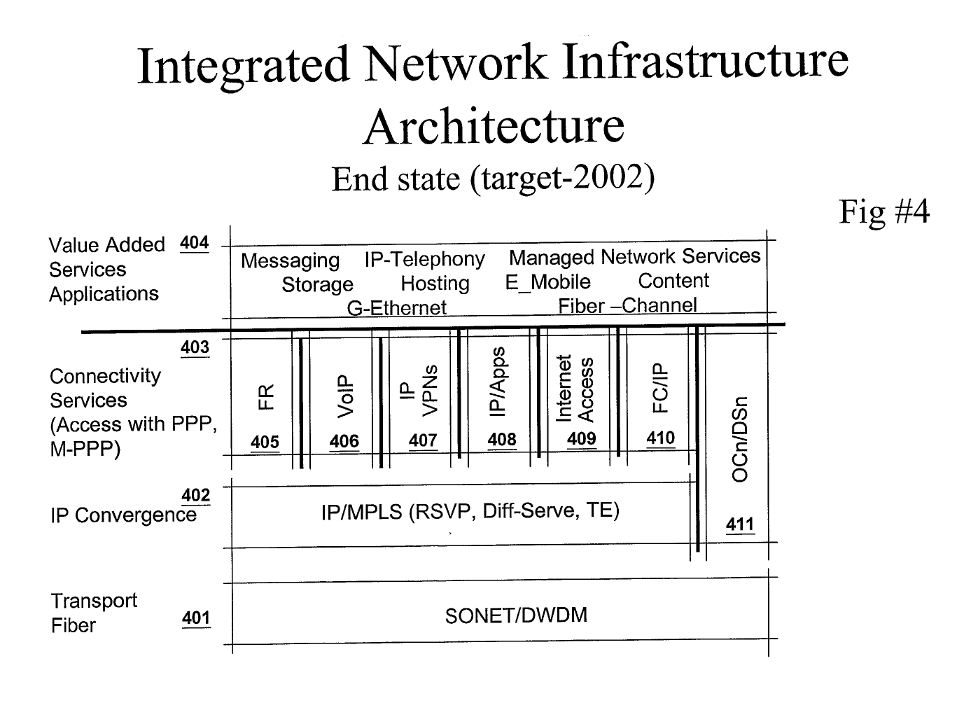

An embodiment of a packet based integrated network infrastructure architecture (PBINI) 101, shown in FIG. 1, is shown in FIG. 4. FIG. 4 shows an embodiment of PBINI 101 in which converged service is provided over an IP Multi-protocol Label Switching (MPLS) infrastructure 402. Resource Reservation Protocol (RSVP) is a set of communication rules that allows channels or paths on a packet-based network to be reserved. In an IP environment Differentiated Services (DiffServ) introduces scalable end-to-end quality of services capabilities. While Traffic Engineering (TE) introduces the ability to control latency and network performance. Edge access 403 is ensured with PPP and/or ML-PPP depending on the bandwidth requirements.

An embodiment of a packet based converged services infrastructure, in accordance with the present invention, is shown in FIG. 5. The embodiment shown in FIG. 5 illustrates a more comprehensive picture of how converged services are provided. Many commercial customers have multiple sites requiring telecommunications services. In this figure, two customer sites (A) & (B) are represented. Customer sites A and B are interconnected with each other through the Integrated Communications System 501,502 and at the same time have access to public services such as the PSTN 514, 518, the Internet 516 and other data based services 517.

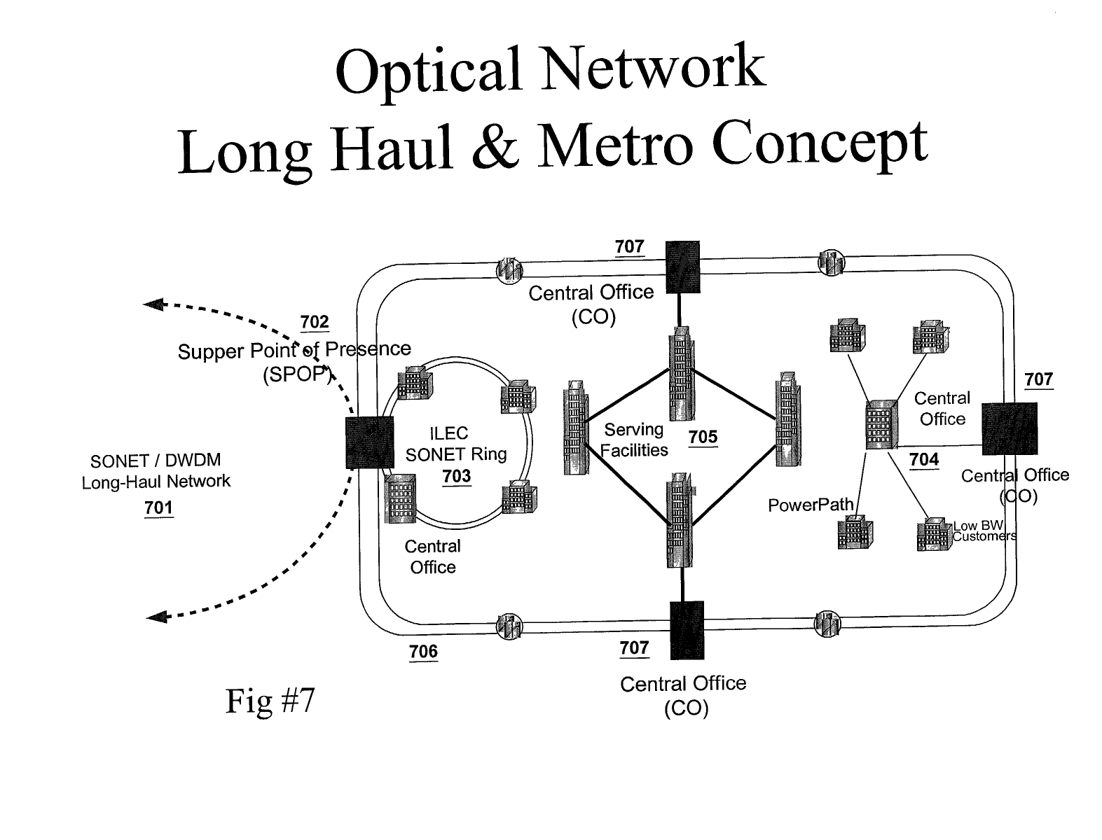

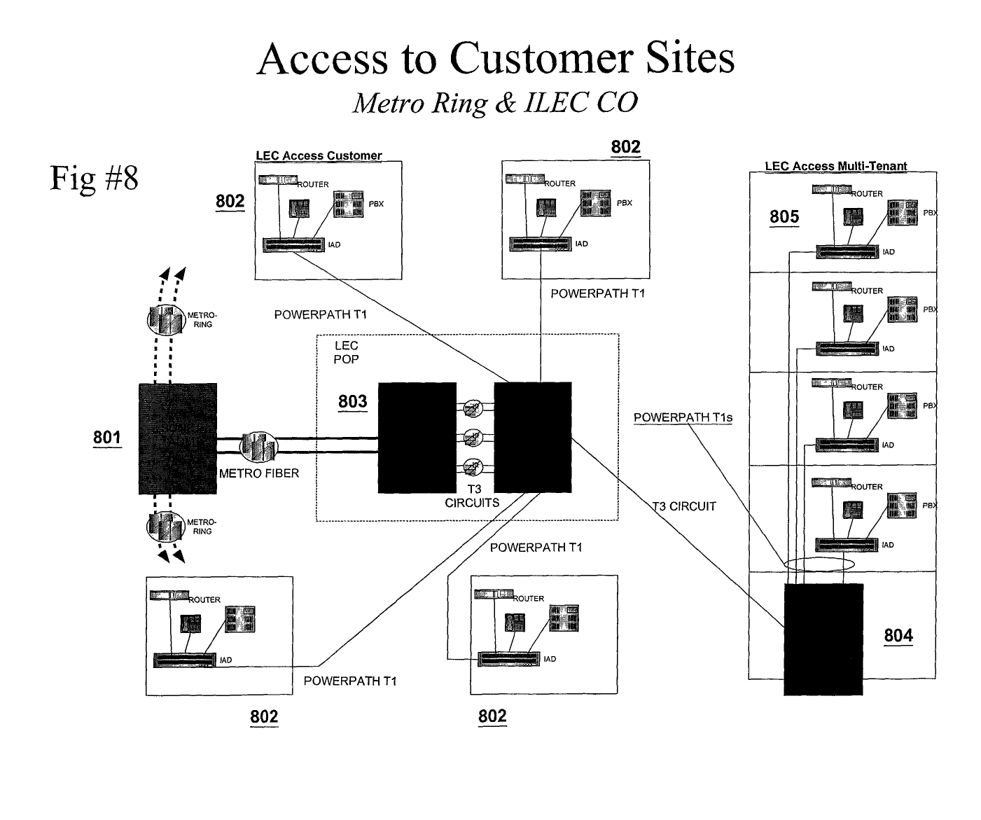

Looking at Customer site (A), this is the customer's Headquarters site, requiring high bandwidth 501 to serve a larger number of on-site users 508, 509 as well as users located on remote sites 507, 508 such as location (B). Users are connected to either legacy Private Branch Exchanges (PBX) 504 or IP Telephony based devices 506. PBXs and data oriented devices such as routers, Local Area Network (LAN) switched or Call Agents supporting IP/Telephony functionalities are connected to IADs 503. An Integrated Access Device (IAD) 503 is a network device that allows the bundling of various telecommunication services into one single packet network infrastructure. It is the tunnel that combines local and long distance voice, Intranet, Extranet and Internet data requirements as well as videoconferencing. The IAD is the point of demarcation between the network operator and its customers it is also the extension of the ICS to the customer site. Structurally the IAD also includes router and firewall functionalities. Customers can connect any of their telecommunications equipment as the IAD can adapt to analog and digital interfaces and handle divers protocols. From a voice perspective, the IADs support Primary Rate Interface (PRI) with Common Channel Signaling (CCS) and Channelized T1s with Channel Associated Signaling (CAS). Both analog and digital interface ports are available. On the data side both serial ports and Ethernet ports are available. Location (A) is served with a Powerpath making use of two T1 circuits 501 extending transport through a serving Central Office (CO) into Super Point of Presence (SPOP), shown in FIG. 7 and FIG. 8.

A Super Point of Presence (SPOP) has three major functional roles. One, it functions as the main network node hosting the switching, routing and transport fiber network infrastructure. Second it has a data center functionality hosting Information Management Platform (including back office functionality). And third it is a hosting facility for value added services provided to customers. In this last instance, the operator of the SPOP is hosting customer servers and storage devices as part of its ASP service offering. From a structural point of view the network architecture, shown in FIG. 2 represents the various layers of the network elements that are engineered in the SPOP. FIGS. 9 and 10 show the architecture of the Activation Engine and the Information Management Platform, as FIG. 1 in its upper layer represents the value added services that are made available to customers.

All access links to customer locations are called PowerPath 501, 502. The Powerpath connected to Location (A) makes use of Inverse Multiplexing for ATM (IMA) and therefore with two T1s, sees a full 3 Mbps transparent transport connection. The PowerPath is delivered at the customer site with an Integrated Access Device (IAD) 503, which is functionally the point of interconnection to the customer. The IAD is an integral part of the Integrated Communications System. Location (A) has multiple virtual trunks dedicated to both Local and long distance voice. Local voice is terminated at an Incumbent Local Exchange Carrier (ILEC) 518 central office while long distance traffic is terminated with an Inter-Exchange Carrier (IXC) 514 point of presence. A voice Gateway 513 assures the interconnection between the ICS and PSTN Carriers. The ICS interconnects in a fully redundant mode with all ILEC Tandem Switches on a Local Access & Transport Area (LATA) by LATA basis 515 and multiple interconnects are ensured with IXCs 523. The intra-ICS signaling protocol used to communicate between the Softswitch 512, the IADs 503 and the Softswitch 512 and the voice gateways 513, preferably is the Media Gateway Control Protocol (MGCP) 524. The Powerpath can be provided over a variety of bandwidth sizes starting with a single T1 (1.5 Mbps) to multiple n×T1s (n=up to 8), to a DS3 (45 Mbps) or through OCn services (150 Mbps and up).

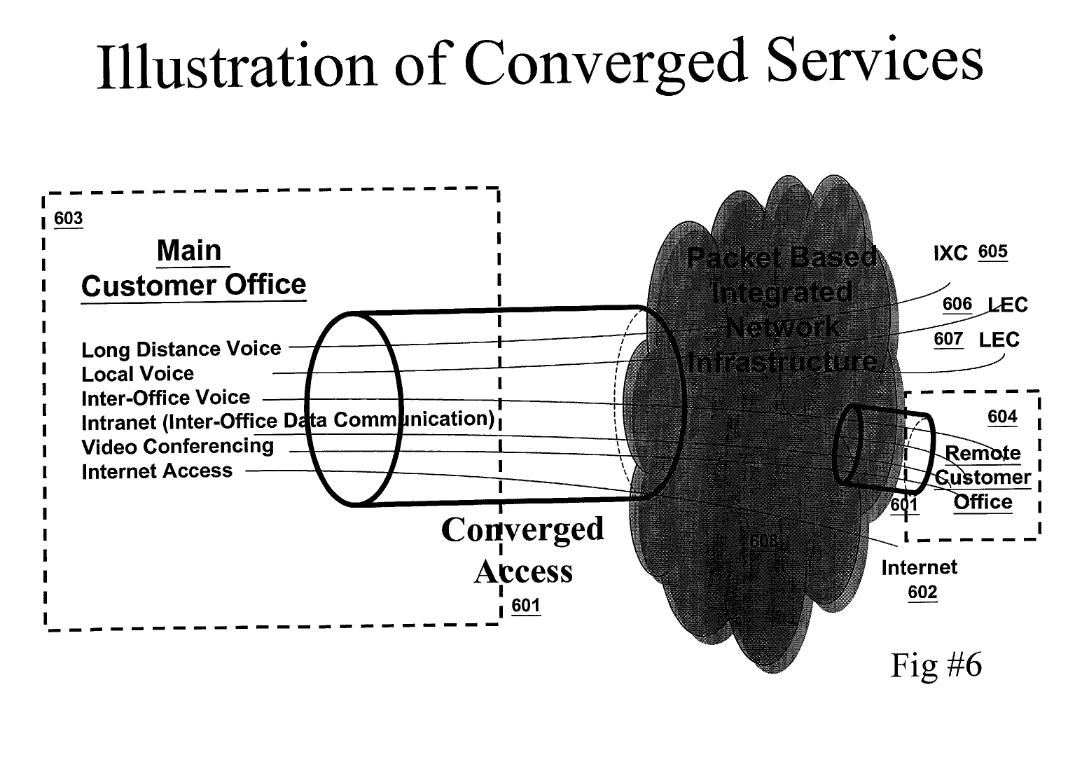

From the same location (A) virtual connections, shown in FIG. 6, with various levels of services, are deployed either to reach a remote site such as (B) or to service providers such as an IXC 605, an ILEC 606, 607, Frame Relay or Internet service providers 602. Location (B) in this example has been assigned a single T1 over which the same services can be provided. Data compression, Voice Activated Detection (VAD) and services priorities are optimizing the use of bandwidth between the customer sites and the ICS' Super Points of Presence (SPOPs). From a signaling point of view the Softswitch FIG. 5 512 is the switching director of the Integrated Communications System. It permits the establishment and termination of voice calls across the network or into and from the Public Switched Telephone Network (PSTN). A local call requires a lookup at the Softswitch, as a long distance call further requires a lookup at the Switched Control Point (SCP) 516. The SCP provides the signaling link 519 to the legacy world using a SS7 signaling protocol. The SS7 network includes multiple Switched Transfer Points (STP) 521 reaching all carriers worldwide. The ICS can inter-connect to both legacy PSTNs and packet based new generations PSTNs. Redundant accesses to 911 525 and Operating Services, Directory Assistance (OSDA) 522 are ensured through the ICS. FIG. 5 also describes connections to data centers 526 residing on SPOPs. These data centers are hosting the ICS infrastructure elements including the Routing and Switching fabrics, the Information Management Platform (IMP), the Activation Engine and customer infrastructure elements provided through the value added services platform.

An embodiment of a packet based converged services illustration in accordance with the present invention is shown in FIG. 6. FIG. 6 illustrates a detailed picture of how virtual connections are extended over the ICS. The Converged Access 601 or PowerPath is the ICS link to the commercial customer premises. Multiple virtual; connections are extended to the customer with various levels of services depending on the application 603. There can be multiple remote sites such as described under 604, and as already mentioned connections to other carriers are accommodated through gateways 605, 606, 607.

Referring now to FIG. 7, an embodiment of an Optical Network Concept covering Long-Haul and Metro Areas in accordance with the present invention is shown. FIG. 7 represents the supporting Long-Haul and Metro optical network concept. The left hand doted line 701 represents the Long-Haul network segment interconnecting major ICS sites in the footprint of operation. The technology deployed in the long haul area is based on DWDM optronics. It secures the base of virtually unlimited bandwidth capacity. Terminal sites 702 are serving major ICS end-points while optical add-drop multiplexers (OADM) can serve intermediate sites, or sites that are initially not served. The second ring in FIG. 7 706 shows a typical Metro Ring that is built with SONET technology. From a SPOP 702 the Integrated Communications System is extending services either to other Central Offices 707, tenant owned facilities 705 or to distant Central Offices 707/704 where fiber is not yet available. The important aspect is that the routing and switching fabrics are centrally located 702 and that the optical infrastructure is used to extend services to commercial customers. FIG. 7 shows also the various ways ICS services can be extended to commercial customers. From the ICS SPOP 702 an ILEC SONET ring 703 can be extended into facilities serving multiple building tenants. As an alternative under 705 an optical meshed SONET configuration is replacing the ring configuration pictured under 703. Under 704 where no optical connections are available, ICS services can be extended over traditional copper TDM based transport solutions.

Referring now to FIG. 8, an embodiment of an Optical Network Concept covering Access to commercial customer sites is shown. FIG. 8 shows examples of ICS connectivity options extended from an ILEC Central Office 803 to customer sites 802 making use of traditional copper based transport media such as T1s, multiple T1s or T3s. It also shows how the Integrated Communications System can be extended into a multi-tenant environment 804 terminating services with its IAD at different floor levels 805.

Referring now to FIG. 9, an embodiment of an ICS Activation Engine (AE) Concept in accordance with the present invention is shown. FIG. 9 represents the Activation Engine Concept a major component of the Integrated Communications System permitting the interconnection of all network elements with the Information Management Platform. The Activation Engine allows for the flow-through provisioning of services. This same powerful concept will later allow customers to self-provision services on the Internet. The key elements of the AE are the Provision Control Center (PCC) 905 a Portal that provides ICS operations resources with a menu driven user interface. The Operations Support System (OSS) 906 provides the capability to order, provision, maintain and bill ICS based services. The Softswitch 907 provides the signaling fabric for all voice communications across the ICS. The Softswitch is also the director of calls to and from the PSTN. It communicates with the PSTN using the SS7 signaling protocol. The Data Bus 901 or middleware provides the basis to interconnect the various elements directors and the Information Management Platform. The Core Element Manager 902 directs the ATM switches 908 and Shelfs 909. The Edge Element Manager 903 directs the IADs 910, 911, 912 as well as core 913 and edge 914 routers. The Optronics Element Manager 904 is directing DWDM 915 and SONET 916 network elements.

An embodiment of an Information Management Platform in accordance with the present invention is shown in FIG. 10. The Information Management Platform (IMP) is based on a multi-tier architecture that encompasses Data Mart(s) at the very top of the model 1008 supporting non-real time information for archiving and reporting purposes. A middleware data bus 1002 has the task to inter-connect with the various layers. The Business Application Layer 1003 is hosting the billing system 1011, the Operations Support System 1009, the Customer Relationship Management (CRM) 1012, the Electronic Data InterExchange engine 1013 and other finance 1014 and HR 1015 functional applications. The Network Management Layer (NMS) 1004 includes, all Network Management Tools 1018 as well as the activation engine. The Element Manager Layer (EMS) 1005 is including the Softswitch 1019 and the Accounting Gateway 1020. A layer of portals 1006 provides a seamless customized and controlled access to information for end user such as customers, partners, and employees. All are making use of web centric clients 1021. Authentication and security validation are required to gain access to information.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

### GLOSSARY

1) Converged telecommunications services

The integration (bundling) of multiple services such as voice, data and videoconferencing in one service (i.e. PowerPath service offering)

2) Commercial customers

Mid and large size companies from various industries. Commercial customers usually have voice switches and data routers that require to be connected as in opposition to residential users that do not have such devices and therefore require a different type of inter-connection.

3) A packet based integrated network infrastructure

A network that is based on packet technology such as IP (Internet Protocol) as opposed to circuit switching such the traditional Public Switched Telephone Network (PSTN).

4) An activation engine

A sub-system developed to support end-to-end provisioning across its network infrastructure. A sub-system that interacts with both the network and the Information Management Platform.

5) Flow-through provisioning

The activity of provisioning a service end-to-end across the multi-layer packet network infrastructure.

6) Information Management Platform

A sub-system integrating the systems and applications.

7) Handling orders

The activity to place services orders.

8) Maintaining service quality

The ability to deliver services based on service level agreements.

9) Billing and administration

The ability to bill and administrating a customer account.

10)Packet based communications

Setting up a communication that is packet based as opposed to switched circuits based.

11)Private Branch Exchanges (PBXs)

A voice switch that resides at the commercial user premises interconnecting telephone devices to local and long distance voice services.

12)Routers

A device that routes packets either at the customer premises or routers that are part of the network infrastructure. Routers are the essential part of a packet based network infrastructure.

13)Intranet

An enterprise network that is build based on Internet principles. The enterprise network is a closed user group network that focuses primarily on enterprise requirements.

14)Internet

The Internet is a network of networks. It is an interconnection of thousands of local, regional, national and international computer networks. The Internet often referred to the “Net”, is the largest computer network in the world. This interconnected network is a single global, logical network.

What is claimed is:

1. An integrated communications system comprising:
an integrated packet-based network infrastructure operable to provide networked converged communications;
an information management platform operable to support handling of orders, initiating services provisioning, maintaining service quality, billing, and administration; and
an activation engine operable to provide end-to-end services provisioning.

2. The system of claim 1, wherein the integrated packet-based network infrastructure replaces a traditional circuit switched network.

3. The system of claim 2, wherein the integrated packet-based network infrastructure is operable to provide networked converged communications to commercial users.

4. The system of claim 1, wherein the integrated network infrastructure comprises:
a transport layer operable to transport data signals;
a routing and switching layer operable to provide routing and switching of network traffic transported by the transport layer;
a connectivity layer operable to provide end-user converged communications services.

5. The system of claim 4, wherein the connectivity layer is operable to provide end-user converged communications services to commercial user locations.

6. The system of claim 4, wherein the transport layer is based on wavelength division multiplexing and synchronous optical network technology and comprises redundant path protected fiber links.

7. The system of claim 6, wherein the fiber link extends from a super point of presence to at least one central office and at least one commercial customer premise.

8. The system of claim 4, wherein the routing and switching layer comprises Internet protocol over asynchronous transfer mode.

9. The system of claim 8, wherein the routing and switching layer further comprises a packet-based infrastructure combining multiple services over a single network media.

10. The system of claim 8, wherein the end-user communications services comprise at least one of:
converged services with frame relay services, voice over Internet protocol with local and long distance calling capabilities, Internet access, and videoconferencing.

11. The system of claim 10, wherein the converged services comprise a value added services layer operable to provide web hosting, storage, managed network services, and messaging services.

12. The system of claim 8, wherein the routing and switching layer is further operable to provide multi-protocol label switching.

13. The system of claim 12, wherein the routing and switching layer is further operable to provide virtual private network capabilities.

14. The system of claim 12, wherein the routing and switching layer is further operable to provide a capability for any end-user to communicate with any other end-user independently of geographic location.

15. The system of claim 12, wherein the routing and switching layer further operable to provide virtual private network capabilities across multiple networks, including the Internet.

16. The system of claim 12, wherein the end-user communications services comprise at least one of:
converged services with frame relay services, voice over Internet protocol with local and long distance calling capabilities, Internet access, and videoconferencing.

17. The system of claim 16, wherein the converged services comprise a value added services layer operable to provide web hosting, storage, managed network services, and unified messaging service.

18. The system of claim 1, further comprising an integrated access device located at a customer premise.

19. The system of claim 18, wherein the integrated access device is operable to provide a channel associate signaling interface.

20. The system of claim 18, wherein the integrated access device comprises analog and digital voice interfaces.

21. The system of claim 18, wherein the integrated access devise comprises serial data ports and at least one network Ethernet port.

22. The system of claim 18, wherein the integrated access device is operable to provide a primary rate voice interface.

23. The system of claim 18, wherein the integrated access device encompasses routing and firewall functionality.

24. The system of claim 18, wherein the trunk interface comprises at least one of T1, multiple T1s, DS3, and OCn capabilities.

25. The system of claim 1, wherein the information management platform is further operable to provide customer on-network access to billing, usage, and performance information.

26. The system of claim 1, further comprising a super point of presence where the Information Management Platform allows customer on-net access to billing, usage and performance information.

27. The system of claim 1, further comprising a super point of presence where the Information Management Platform allows the management of information including ordering, provisioning, maintaining and billing of services.

28. The system of claim 1, further comprising a super point of presence where the activation engine executes the provisioning of services initiated by the information management platform.

29. The system of claim 1, further comprising a super point of presence operable to provide commercial customers with hosting facilities supporting value added services.
